(19) United States
(12) Patent Application Publication
(10) Pub. No.: US 2026/0074608 A1
(43) Pub. Date: Mar. 12, 2026

(54) BUCK TYPE SWITCHED-MODE POWER SUPPLY

(71) Applicant: STMicroelectronics International N.V., Geneva (CH)

(72) Inventors: Eric FELTRIN, Grenoble (FR); David CHESNEAU, Grenoble (FR); Helene ESCH, Seyssinet Pariset (FR)

(73) Assignee: STMicroelectronics International N.V., Geneva (CH)

(21) Appl. No.: 19/316,441

(22) Filed: Sep. 2, 2025

(30) Foreign Application Priority Data
Sep. 12, 2024 (FR) FR2409717

(51) Int. Cl. H02M 1/088; H02M 3/158

(52) U.S. Cl. CPC H02M 1/088; H02M 3/158

(57) ABSTRACT

A buck-type switched-mode power supply includes a switching cell formed by a first switch configured to be periodically set to the on state by a first control signal modulated by a modulation of pulse-width or pulse-frequency modulation type. An amplifier generates an error voltage representative of a difference between a reference voltage and an output voltage of the power supply intended to be applied to the input of the amplifier. A delay circuit applies a delay to the first control signal to decreasing a difference between the error voltage and the reference voltage. A delay modulation circuit modulates the value of the delay according to a difference between the error voltage and the reference voltage.

### PRIORITY CLAIM

This application claims the priority benefit of French Application for Patent No. FR2409717, filed on Sep. 12, 2024, the content of which is hereby incorporated by reference in its entirety to the maximum extent allowable by law.

### TECHNICAL FIELD

The present disclosure generally concerns the field of switched-mode power supplies (SMPS), particularly with respect to DC-DC converters, and more particularly buck-type switched-mode power supplies (also known as buck converters or step-down choppers).

### BACKGROUND

A buck-type switched-mode power supply generally comprises a switching cell comprising a first so-called “high-side” transistor and a second so-called “low-side” transistor coupled in series between an input electrical potential and ground. The first and second transistors, of complementary types (one of type n and the other of type p), are alternately set to the on state and to the off state, complementarily (one is in the on state while the other is in the off state), by complementary first and second control signals applied to their gates. A low-pass LC filter is coupled to the connection node of this cell, that is, to the connection point to which are coupled the two transistors. The output voltage of the power supply is obtained across the filter capacitor.

The control signals applied to the transistors are either in pulse width modulation (PWM) or in pulse frequency modulation (PFM). The level of the obtained output voltage is a function of the duration of the on and off states of the transistors during a period of the control signals. The modulation parameters of these control signals define the conversion ratio of the power supply.

In the presence of a strong load coupled to the output of the power supply, a significant output current is required. The power supply operates in this case with PWM-type modulated signals for controlling the transistors of the switching cell, and the frequency of these control signals is then fixed. The power supply comprises a circuit generating an error voltage having a value depending on the difference between the value of the output voltage and that of a reference voltage corresponding to the target value of the output voltage, and another circuit generating a ramp voltage which rises from zero and which, on reaching the value of the error voltage, defines the duration of a first state of the control signals during which the switching cell charges the capacitor coupled to the connection node of the switching cell.

In the presence of a small load coupled to the output of the power supply, a low output current is required. The power supply then operates with PFM-type modulated signals for controlling the transistors of the switching cell.

In such a switched-mode power supply, the output voltage of the power supply strongly fluctuates during a change in the modulation of the control signals (switching between the PWM and PFM modulations) if, at the time of this change, the error voltage and the reference voltage are not equal.

To avoid this problem, U.S. Pat. No. 10,944,324 (also EP 3 644 486 A1) teaches the introduction of a delay modifying the value of the error voltage in order to decrease the difference between the value of the error voltage and that of the reference voltage. This delay is defined as being equal to the propagation time of the comparator of the error voltage with the ramp voltage. This delay forces the control loop of the power supply to artificially increase the error voltage so as to obtain the same duty cycle enabling the error voltage to approach the reference voltage, and thus improve transitions between PWM and PFM modulations.

A disadvantage of the solution provided in the above-mentioned reference is that the maximum value of the duty cycle obtained for PWM modulation is limited by the introducing of this delay, which may lead to a limited performance of the power supply.

There is accordingly a need in the art to provide a solution deprived of have at least part of the disadvantages of existing solutions.

### SUMMARY

In an embodiment, a buck-type switched-mode power supply comprises at least: a switching cell comprising at least a first switch configured to be periodically switched to the on state by a first control signal modulated by a modulation of the type of a pulse-width modulation (PWM) or pulse-frequency modulation (PFM); an amplifier configured to generate an error voltage representative of a difference between a reference voltage and an output voltage of the power supply intended to be applied to the input of the amplifier; a delay circuit configured to apply to the first control signal a delay decreasing a difference between the error voltage and the reference voltage; and a delay modulation circuit configured to modulate the value of the delay according to a difference between the error voltage and the reference voltage.

According to a specific embodiment, the delay modulation circuit is configured to deliver as an output a current or a voltage having a value proportional to the difference between the error voltage and the reference voltage.

According to a specific embodiment, the delay modulation circuit is configured to decrease the value of the delay proportionally to the value of the difference between the error voltage and the reference voltage.

According to a specific embodiment, the delay modulation circuit comprises at least one differential amplifier comprising a non-inverting input configured to receive the error voltage and an inverting input configured to receive the reference voltage.

According to a specific embodiment, the switching cell comprises at least a second switch configured to be periodically set to the on state by a second control signal modulated by a modulation of PWM or PFM type, complementarily to the first switch.

According to a specific embodiment, the switched-mode power supply further comprises at least one inductive element comprising a first electrode coupled to a connection node of the switching cell, and at least one capacitive element coupled to a second electrode of the inductive element and across which the output voltage of the power supply is intended to be obtained.

According to a specific embodiment, the switched-mode power supply further comprises at least one comparator configured to receive as an input the error voltage and a periodic increasing voltage ramp during a period of the first control signal.

According to a specific embodiment, the switched-mode power supply further comprises at least one circuit for generating a control signal configured to generate at least the first control signal from the output signal of the comparator and from an output signal of the delay circuit.

According to a specific embodiment, the switched-mode power supply further comprises a voltage ramp generation circuit configured to generate the ramp voltage and having its output coupled to a non-inverting input of the comparator.

According to a specific embodiment, the switched-mode power supply further comprises a circuit for generating a periodic signal configured to deliver, at the input of the delay circuit and of the voltage ramp generation circuit, a periodic signal having a frequency equal to a frequency of the first control signal.

According to a specific embodiment, the delay circuit comprises at least: a CMOS inverter configured to receive as input the periodic signal delivered by the periodic signal generation circuit; a capacitive element coupled to an output terminal of the inverter; a Schmitt trigger comprising an input coupled to the output terminal of the inverter and having an output forming an output of the delay circuit; a MOS transistor configured to deliver as an output a current having a maximum value lower than that of the transistors of the inverter, and coupled in series with one of the transistors of the inverter; and a current source configured to draw, from a connection node between the MOS transistor and the inverter, the current having a value proportional to the difference between the error voltage and the reference voltage.

In an embodiment, a method of converting an input voltage into an output voltage having a value lower than that of the input voltage comprises at least: controlling at least one switching cell comprising at least one first switch periodically set to the on state by a first control signal modulated by a modulation of the type of a pulse-width modulation (PWM) or pulse-frequency modulation (PFM); generating an error voltage representative of a difference between a reference voltage and an output voltage of the power supply; generating a delay decreasing an interval between the error voltage and the reference voltage; modulating the value of the delay as a function of a difference between the error voltage and the reference voltage; and applying the modulated delay to the first control signal.

According to a specific embodiment, the modulation of the value of the delay comprises the generation of a current or of a voltage having a value proportional to the difference between the error voltage and the reference voltage.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 schematically shows a switched-mode power supply;

FIG. 2 schematically shows an example of embodiment of a voltage ramp generation circuit of a switched-mode power supply;

FIG. 3 schematically shows an example of embodiment of a delay circuit of a switched-mode power supply;

FIG. 4 schematically shows an example of embodiment of a delay modulation circuit of a switched-mode power supply;

FIG. 5 shows an example of output current of a delay modulation circuit of a switched-mode power supply; and

FIG. 6 shows examples of signals obtained in a switched-mode power supply.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail. In particular, the forming of various elements and components of the switched-mode power supply is not detailed. Those skilled in the art will be capable of forming these elements in detail based on the description given herein.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements. Further, the term “coupled” is here used to designate an electrical coupling between a plurality of electrical and/or electronic elements (components, circuits, etc.).

Unless specified otherwise, the expressions “about”, “approximately”, “substantially”, and “in the order of” signify plus or minus 10%, preferably of plus or minus 5%. Similarly, unless otherwise specified, the indicated ranges of values include the limits of these ranges.

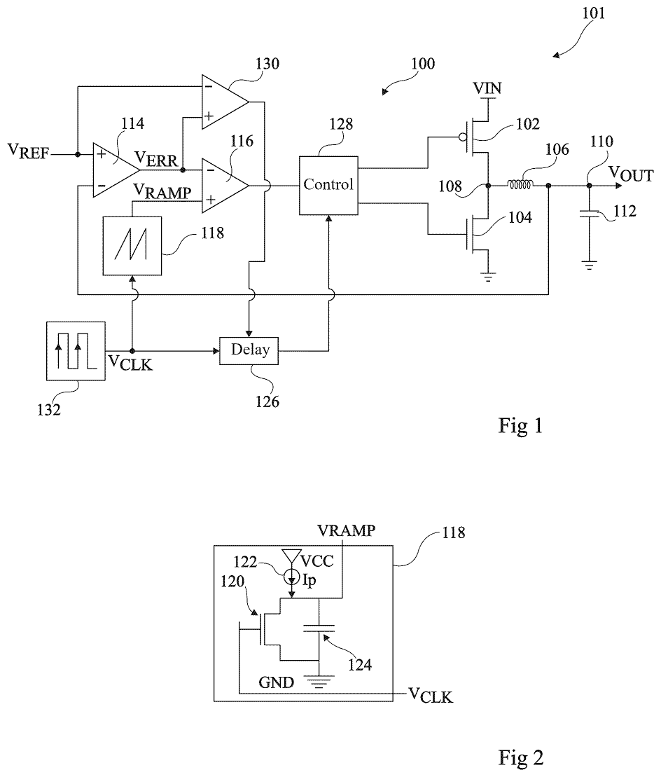

A switched-mode power supply 100 according to a specific embodiment is described hereafter in relation with FIG. 1. Part only of the elements, circuits, and components of power supply 100 are described hereafter and shown in FIG. 1, power supply 100 being likely to comprise other electrical or electronic elements, circuits, and components.

Power supply 100 corresponds to a buck-type switched-mode power supply, that is, corresponds to a buck converter.

In the example described in FIG. 1, power supply 100 comprises a switching cell 101 comprising a first power transistor 102 and a second power transistor 104. The two transistors 102, 104 are of opposite types, one of type n and the other of type p. In the example of FIG. 1, the first transistor 102 corresponds to a PMOS transistor and the second transistor 104 corresponds to an NMOS transistor.

As a variant, switching cell 101 may comprise switches other than MOS transistors (IGBT, bipolar transistor, etc.). Further, one of the two switches of switching cell 101 may be replaced by a diode.

Transistors 102 and 104 are coupled in series between an electrical input potential of power supply 100 and ground, forming an input voltage V_{IN} applied across switching cell 101.

In the described example of embodiment, first and second control signals are intended to be applied to the gates of transistors 102, 104 (the first control signal being applied to the gate of the first transistor 102, and second control signal being applied to the gate of the second transistor 104), and thus control the switching of cell 101. During the operation of power supply 100, transistors 102, 104 are intended to be in complementary states (one of the two transistors 102, 104 is on, the other of the two transistors 102, 104 is off) when they are controlled by control signals modulated by a PWM-type modulation. During the use of a PFM-type modulation, transistors 102, 104 may both be in the off state.

In the example of FIG. 1, power supply 100 further comprises an inductive element 106, comprising for example an inductor, provided with a first electrode coupled to a connection node 108 of switching cell 101 (the node to which the two transistors 102, 104 are coupled), and with a second electrode coupled to an output terminal 110 of power supply 100 on which an output current of power supply 100 is intended to be obtained.

In the example of FIG. 1, power supply 100 further comprises a capacitive element 112, comprising for example a capacitor, coupled between output terminal 110 and ground, and across which an output voltage V_{OUT} is intended to be obtained. Capacitive element 112 forms, together with inductive element 106, a low-pass filter.

In the specific embodiment described, power supply 100 further comprises an amplifier 114 configured to generate an error voltage V_{ERR} representative of a difference between a reference voltage V_{REF} and output voltage V_{OUT}. In this example, amplifier 114 comprises an integrator provided with a correction function for stabilizing the control loop of power supply 100. In the example of FIG. 1, reference voltage V_{REF} is intended to be applied to a non-inverting input of amplifier 114, and output voltage V_{OUT} is intended to be applied to an inverting input of amplifier 114. The error voltage V_{ERR} obtained at the output of amplifier 114 corresponds to a DC voltage centered on the reference voltage, having a value lower than that of reference voltage V_{REF} when the value of reference voltage V_{REF} is lower than that of output voltage V_{OUT}, and having a value higher than that of reference voltage V_{REF} when the value of reference voltage V_{REF} is higher than that of output voltage V_{OUT}.

The value of the reference voltage V_{REF} to be applied to the input of amplifier 114 is selected to be equal to the target value of output voltage V_{OUT}. For example, input voltage V_{IN} may be equal to 3 V, and output voltage V_{OUT} (and thus also reference voltage V_{REF}) may be equal to 1 V. In this example, the conversion ratio of power supply 100 is 1/3.

In the example of FIG. 1, power supply 100 further comprises a comparator 116 comprising an inverting input coupled to the output of amplifier 114, that is, to which error voltage V_{ERR} is intended to be applied, and a non-inverting input to which a periodic voltage ramp V_{RAMP}, obtained at the output of a voltage ramp generation circuit 118, is intended to be applied. The voltage obtained at the output of comparator 116 corresponds to a square-wave signal having a first value (corresponding to a low state in the example of FIG. 1) when the value of periodic voltage ramp V_{RAMP} is lower than error voltage V_{ERR}, and a second value (corresponding to a high state in the example of FIG. 1) when the value of periodic voltage ramp V_{RAMP} becomes higher than error voltage V_{ERR.}

The duration of the low state of the output signal of comparator 116 thus corresponds to the time during which the value of periodic voltage ramp V_{RAMP} increases to reach the value of error voltage V_{ERR}. Now, given that error voltage V_{ERR} is generated as a function of the difference between reference voltage V_{REF} and output voltage V_{OUT}, this duration of the low state of the output signal of comparator 116 is also a function of the value difference between reference voltage V_{REF} and output voltage V_{OUT}. The output signal of comparator 116 thus is a periodic square-wave signal having a duty cycle depending on the difference between reference voltage V_{REF} and output voltage V_{OUT}.

An example of embodiment of periodic voltage ramp generation circuit 118 is described hereafter in relation with FIG. 2.

In this example, circuit 118 comprises a transistor 120 (an NMOS transistor in the example of FIG. 2). A ramp control signal V_{CLK}, here corresponding to a square-wave signal, is intended to be applied to the gate of transistor 120. Circuit 118 further comprises a current source 122 coupled between an electrical power supply potential VCC and the drain of transistor 120 and configured to deliver a bias current Ip. Circuit 118 further comprises a capacitor 124 intended to be charged by bias current Ip and coupled between the drain of transistor 120 and ground. Periodic voltage ramp V_{RAMP} is intended to be obtained across the capacitor 124.

In the example of embodiment of circuit 118 shown in FIG. 2, when ramp control signal V_{CLK} is in a low state (“0”), setting transistor 120 to the off state, the bias current Ip delivered by current source 122 charges capacitor 124, and the value of V_{RAMP} increases linearly. When the ramp control signal switches to a high state (“1”), setting transistor 120 to the on state, the value of periodic voltage ramp V_{RAMP} drops back to zero. The period of the ramp control signal is equal to the period of the control signals intended to be applied to the gates of transistors 102, 104.

Other alternative embodiments of voltage ramp generation circuit 118 are possible.

Power supply 100 further comprises a delay circuit 126 configured to introduce, into the control signals intended to be applied to the gates of the transistors 102, 104 of cell 101, a delay decreasing a difference between error voltage V_{ERR} and reference voltage V_{REF}, when these control signals are modulated by PWM modulation to facilitate the transition from one to the other of the PWM and PFM modulations of the control signals.

In the example of FIG. 1, a delayed clock signal is delivered at the output of delay circuit 126 and applied to the input of a control signal generation circuit 128. Circuit 128 is configured to generate, based on the signal delivered at the output of comparator 116 and on the delayed clock signal delivered at the output of delay circuit 126, first and second control signals intended to be applied to the gates of the transistors 102, 104 of cell 101. For example, the first and second control signals are such that the first transistor 102 turns on and the second transistor 104 is off during the rising edge of the delayed clock signal. Then, when the delayed clock signal changes state and exhibits a falling edge, the second transistor 104 turns on and the first transistor 102 turns off.

Control circuit 128 comprises, for example, a digital controller, for example of finite state machine (FSM) type. As a variant, when switching cell 101 comprises a single switch, circuit 128 may be configured to output a single control signal.

Power supply 100 further comprises a delay modulation circuit 130 configured to modulate the value of the delay defined in the delayed clock signal delivered by delay circuit 126 according to a difference between error voltage V_{ERR} and reference voltage V_{REF}. In the example shown in FIG. 1, delay modulation circuit 130 comprises a differential amplifier with a non-inverting input to which error voltage V_{ERR} is intended to be applied, and an inverting input to which reference voltage V_{REF} is intended to be applied. In this example, a current called Iadd having a value proportional to the difference between the value of error voltage V_{ERR} and that of reference voltage V_{REF} is obtained at the output of delay modulation circuit 130. As a variant, delay modulation circuit 130 could output a voltage having a value proportional to the difference between the value of error voltage V_{ERR} and that of reference voltage V_{REF.}

In the described example of embodiment, power supply 100 further comprises a periodic square-wave signal generation circuit 132 configured to output a periodic square-wave signal corresponding to ramp control signal V_{CLK}. In the example of FIG. 1, ramp control signal V_{CLK} is also applied to the input of delay circuit 126.

In power supply 100, the different paths taken by the various signals and voltages have the consequence of generating a time delay between error voltage V_{ERR} and reference voltage V_{REF}. In the described example of embodiment, this delay is due in particular to comparator 116, which is formed of a plurality of transistors and which generates a relatively significant processing time with respect to the period of periodic square-wave signal V_{CLK}. There thus exists a given signal propagation time between the input and output of comparator 116.

To overcome this disadvantage, delay circuit 126 is configured to output a clock signal delayed by a delay having a value in the range from the value of the signal propagation time in comparator 116 to a zero value, according to the modulation of the delay applied by delay modulation circuit 130. In the described example, delay modulation circuit 130 is configured to decrease the value of the delay proportionally to the value of the difference between error voltage V_{ERR} and reference voltage V_{REF}, and in such a way that the value of the delay is maximum when the value of error voltage V_{ERR} is lower than that of reference voltage V_{REF}. The value of the delay is decreased and tends towards zero when the value of error voltage V_{ERR} is equal to reference voltage V_{REF.}

For example, the value of the signal propagation time in comparator 116 may be estimated during a phase of calibration of power supply 100. Delay circuit 126 can then be configured to apply by default a delay equal to the value of the signal propagation time in comparator 116, and delay modulation circuit 130 then applies to this delay a coefficient having a value that may be in the range from 0 to 1.

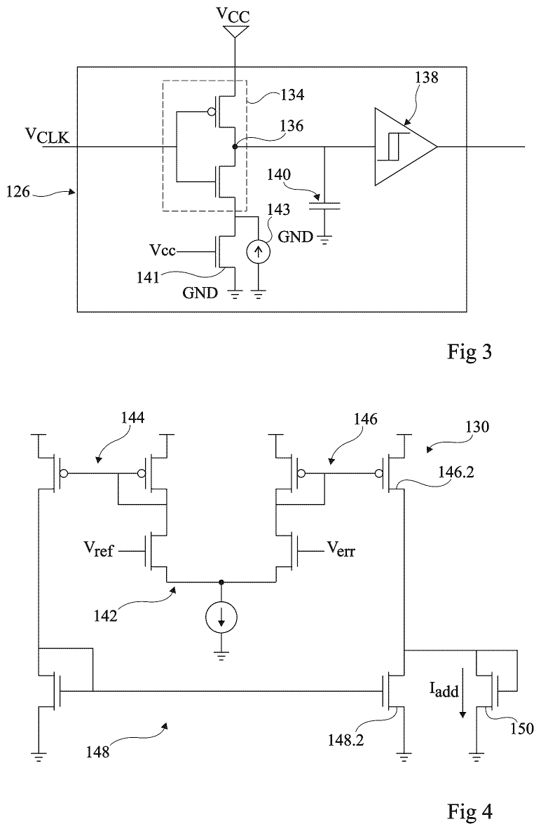

FIG. 3 schematically illustrates an example of embodiment of delay circuit 126.

In this example, delay circuit 126 comprises an inverter 134 here formed of a PMOS transistor and of an NMOS transistor coupled in series, between electrical power supply potential VCC and ground. The gates of the transistors of inverter 134 are coupled together to form an input terminal of delay circuit 126 having ramp control signal V_{CLK} applied thereto. Further, a node 136 to which the transistors of inverter 134 are coupled forms an output terminal of inverter 134.

In the example of FIG. 3, delay circuit 126 further comprises a Schmitt trigger 138 having its input coupled to node 136, and having its output forming the output of delay circuit 126 on which the delayed clock signal is delivered. Further, in this example, delay circuit 126 comprises a capacitive element 140 coupled between node 136 and ground GND.

Delay circuit 126 further comprises a second transistor 141, here of NMOS type, comprising an active area having dimensions smaller than those of the NMOS transistor of inverter 134. In the example of FIG. 3, this second transistor 141 is coupled in series with the NMOS transistor of inverter 134. Delay circuit 126 further comprises a current source 143 drawing current Iadd, the value of which is proportional to the difference between the value of error voltage V_{ERR} and that of reference voltage V_{REF}. This current source 143 corresponds, for example, to a transistor controlled to draw current Iadd. In this example, if V_{CLK} is in the high state, capacitive element 140 discharges through the NMOS transistor of inverter 134 and second transistor 141. The second transistor 141 having small dimensions, the discharge of capacitive element 140 is slow, which creates a delay. Current Iadd adds to the current of transistor 141 to accelerate the discharge of capacitive element 140 through the NMOS transistor of inverter 134. If the value of error voltage V_{ERR} is equal to or close to that of reference voltage V_{REF}, the obtained delay is then maximum, since I_{add} is equal to or close to 0. If the value of error voltage V_{ERR} is much greater than that of reference voltage V_{REF}, current I_{add} is significant and the obtained delay is decreased given the acceleration of the discharge of capacitor 140.

Other alternative embodiments of delay circuit 126 are possible. For example, delay circuit 126 may comprise a structure similar to that of comparator 116, so as to replicate the propagation time of signals in this comparator.

An example of embodiment of a delay modulation circuit 130 is schematically shown in FIG. 4.

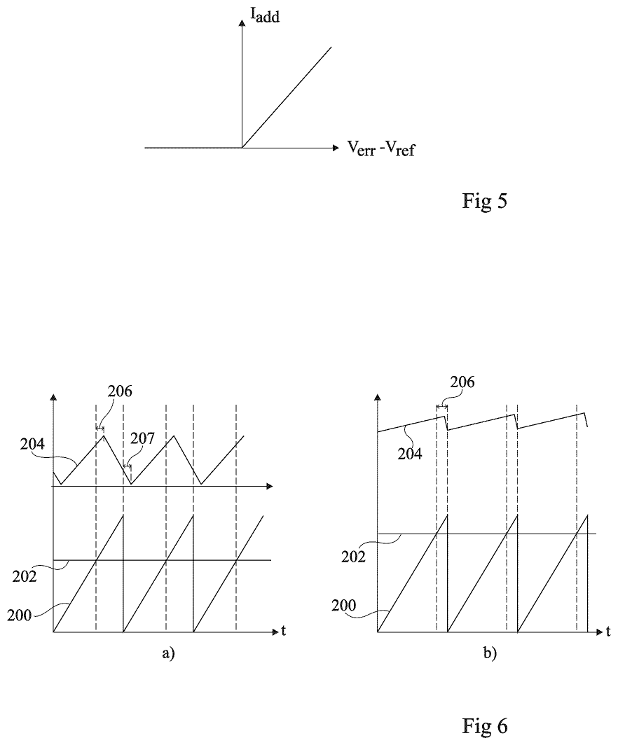

In FIG. 4, delay modulation circuit 130 comprises a differential pair 142, here formed by two CMOS transistors, to which are applied the voltages V_{REF} and V_{ERR} on the transistor gates. The delay modulation circuit 130 shown in FIG. 4 further comprises current mirrors 144, 146, and 148, also formed with CMOS transistors. In this example, the higher error voltage V_{ERR} with respect to reference voltage V_{REF}, the more current the PMOS transistor 146.2 of current mirror 146 delivers, and the less current NMOS transistor 148.2 consumes. Delay modulation circuit 130 further comprises another MOS transistor 150 coupled to the NMOS transistor 148.2 of current mirror 148. The difference in current between that supplied by PMOS transistor 146.2 and that consumed by NMOS transistor 148.2 corresponds to the current I_{add} flowing through transistor 150 and corresponds to the current used to modulate the delay value according to the difference between the error voltage and the reference voltage. FIG. 5 schematically shows the current I_{add} obtained with such a delay modulation circuit 130. In this example, the value of current I_{add} increases linearly proportionally to the value of difference V_{ERR}-V_{REF}.

FIG. 6 shows examples of signals obtained in power supply 100 with a significant charge current (diagram b) and with a low or zero charge current (diagram a).

In the diagram a) of FIG. 6, reference 200 designates the voltage ramp V_{RAMP} obtained at the output of circuit 118, reference 202 designates the value of error voltage V_{ERR} in the case of a PWM modulation and that of reference voltage V_{REF} in the case of a PFM modulation, and reference 204 designates the current flowing through inductive element 106. In diagram a), it is considered that power supply 100 provides very little output current, or that power supply voltage V_{IN} is high. Thus, a first delay 206 appears between the time when voltage ramp V_{RAMP} exceeds the value of error voltage V_{ERR} and the time when the value of current 204 stops increasing and starts decreasing, and a second delay 207 appears between the time when the clock signal switches to the high state, resetting voltage ramp V_{RAMP} to a zero value, and the time when the value of current 204 stops decreasing and increases back. The first delay 206 is mainly due to the response time of comparator 116, and the second delay 207 is due to the delay introduced by delay circuit 126.

In the diagram b) of FIG. 6, power supply 100 outputs a high current or has a power supply voltage V_{IN} close to output voltage V_{OUT}. The value of error voltage V_{ERR} is thus higher than that shown in diagram a). In this diagram b), the first delay 206 appears between the time when voltage ramp V_{RAMP} exceeds the value of error voltage V_{ERR} and the time when the value of current 204 stops increasing and starts decreasing, but the second delay 207 observed in diagram a) does not appear.

In the described specific embodiment, power supply 100 operates in a closed loop and enables to have, if need be, a high value of the duty cycle of one or a plurality of signals for controlling the switch or switches of the switching cell, so as to make output voltage V_{OUT} equal to reference voltage V_{REF}, whatever the value of input voltage V_{IN}.

Further, in the described example of embodiment, power supply 100 is configured to generate a voltage ramp V_{RAMP} controlled by a periodic square-wave signal. This voltage ramp V_{RAMP} is compared with error voltage V_{ERR}, and the control signal(s) sent to switching cell 101 are generated based on this comparison so as to make output voltage V_{OUT} equal to reference voltage V_{REF}.

However, due to the intrinsic signal propagation time, in particular within comparator 116, the duty cycle obtained at the output of comparator 116 is higher than that theoretically obtained, and corresponds to the rise time of voltage ramp V_{RAMP} from error voltage V_{ERR}. Error voltage V_{ERR} tends to decrease so that voltage ramp V_{RAMP} reaches the value of error voltage V_{ERR} earlier than in the ideal case of a power supply with no intrinsic propagation time, in order to compensate for this delay.

With no correction induced by the generated delay, the control loop of power supply 100 would tend to decrease error voltage V_{ERR} to reach the value of the duty cycle necessary for the control of output voltage V_{OUT}. There thus is a difference between error voltage V_{ERR} and reference voltage V_{REF}, according in particular to input voltage V_{IN}.

The fact of applying the delay to the control signal(s) of switching cell 101 when power supply 100 is switched on advantageously enables to start the generation of the voltage ramp before the turning on of the switch or of one of the switches of cell 101 by the control signal(s), so as to compensate for the propagation time intrinsic to the circuits of power supply 100 and to decrease the difference between error voltage V_{ERR} and reference voltage V_{REF}, and a decrease or even an elimination of the influence of input voltage V_{IN} on the quality of transitions between PWM and PFM modulations. These transitions between PWM and PFM modulations become more stable and cause less oscillation on output voltage V_{OUT}.

In the provided power supply 100, the delay applied to the control signal(s) of switching cell 101 decreases together with the value of the difference between error voltage V_{ERR} and reference voltage V_{REF}, which enables to have, if need be, a high duty cycle of the control signal(s), and thus to achieve a better performance of power supply 100, and this, without impacting the bandwidth of power supply 100.

Power supply 100 may, for example, be intended for the automotive industry, in particular for electric vehicles.

Power supply 100 may, for example, be used in the industrial field, for example for the development of green energies or for the electrification of infrastructures, for example for charging stations or for the incorporation of solar energy. The device may also be used in the field of the Internet of Things and of smart homes. The device is for example intended to be implemented in power and energy circuits of equipment.

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given hereabove.

1. A buck-type switched-mode power supply, comprising:
a switching cell comprising a first switch configured to be periodically set to the on state by a first control signal modulated by a modulation type;
an amplifier configured to generate an error voltage representative of a difference between a reference voltage and an output voltage of the power supply;
a delay circuit configured to apply a delay to the first control signal which decreases a difference between the error voltage and the reference voltage; and
a delay modulation circuit configured to modulate a value of the delay according to a difference between the error voltage and the reference voltage.

2. The switched-mode power supply according to claim 1, wherein the modulation type is a pulse-width modulation (PWM).

3. The switched-mode power supply according to claim 1, wherein the modulation type is a pulse-frequency modulation (PFM)
4. The switched-mode power supply according to claim 1, wherein the delay modulation circuit is configured to deliver as an output a current or voltage having a value proportional to the difference between the error voltage and the reference voltage.

5. The switched-mode power supply according to claim 1, wherein the delay modulation circuit is configured to decrease the value of the delay proportionally to the value of the difference between the error voltage and the reference voltage.

6. The switched-mode power supply according to claim 1, wherein the delay modulation circuit comprises at least one differential amplifier comprising a non-inverting input configured to receive the error voltage and an inverting input configured to receive the reference voltage.

7. The switched-mode power supply according to claim 1, wherein the switching cell comprises a second switch configured to be periodically set to the on state by a second control signal modulated by the modulation type, complementarily to the first switch.

8. The switched-mode power supply according to claim 1, further comprising:
an inductive element comprising a first electrode coupled to a connection node of the switching cell; and
a capacitive element coupled to a second electrode of the inductive element and across which the output voltage of the power supply is obtained.

9. The switched-mode power supply according to claim 1, further comprising a comparator configured to receive as an input the error voltage and a periodic increasing voltage ramp during a period of the first control signal.

10. The switched-mode power supply according to claim 9, further comprising a control signal generation circuit configured to generate the first control signal in response to the output signal of the comparator and an output signal of the delay circuit.

11. The switched-mode power supply according to claim 9, further comprising a voltage ramp generation circuit configured to generate the ramp voltage and having its output coupled to a non-inverting input of the comparator.

12. The switched-mode power supply according to claim 9, further comprising a periodic signal generation circuit configured to deliver to the input of the delay circuit and to the voltage ramp generation circuit a periodic signal having a frequency equal to a frequency of the first control signal.

13. The switched-mode power supply according to claim 12, wherein the delay modulation circuit is configured to deliver as an output a current or voltage having a value proportional to the difference between the error voltage and the reference voltage, and wherein the delay circuit comprises:
an inverter configured to receive as an input the periodic signal delivered by the periodic signal generation circuit;
a capacitive element coupled to an output terminal of the inverter;
a Schmitt trigger comprising an input coupled to the output terminal of the inverter and having an output forming an output of the delay circuit;
a transistor configured to deliver as an output a current having a maximum value lower than that of the transistors of the inverter, and coupled in series with one of the transistors of the inverter; and
a current source configured to draw, from a connection node between the transistor and the inverter, the current having a value proportional to the difference between the error voltage and the reference voltage.

14. A method of converting an input voltage into an output voltage having a value lower than that of the input voltage, comprising:
controlling at least one switching cell comprising at least one first switch periodically set to the on state by a first control signal modulated by a modulation type;
generating an error voltage representative of a difference between a reference voltage and an output voltage of the power supply;
generating a delay decreasing a difference between the error voltage and the reference voltage;
modulating the value of the delay as a function of a difference between the error voltage and the reference voltage; and
applying the modulated delay to the first control signal.

15. The conversion method according to claim 14, wherein the modulation type is a pulse-width modulation (PWM).

16. The conversion method according to claim 14, wherein the modulation type is a pulse-frequency modulation (PFM).

17. The conversion method according to claim 14, wherein modulating the value of the delay comprises generating a current or voltage having a value proportional to the difference between the error voltage and the reference voltage.

18. The conversion method according to claim 14, wherein modulating the value of the delay comprises decreasing the value of the delay proportionally to the value of the difference between the error voltage and the reference voltage.

19. The conversion method according to claim 14, wherein modulating the value of the delay comprises determining a difference between the error voltage and the reference voltage.

20. The conversion method according to claim 14, further comprising:
comparing the error voltage and a periodic increasing voltage ramp during a period of the first control signal; and
generating the first control signal in response to comparing and an output signal generated by the delaying.
